(19) United States
(12) Patent Application Publication
(10) Pub. No.: US 2026/0204459 A1
(43) Pub. Date: Jul. 16, 2026

(54) POSITIVE TEMPERATURE COEFFICIENT POLYMER COMPOSITION AND CIRCUIT PROTECTION DEVICE

(71) Applicant: FUZETEC TECHNOLOGY CO., LTD., New Taipei City (TW)

(72) Inventors: Jack Jih-Sang CHEN, New Taipei City (TW); Chang-Hung JIANG, New Taipei City (TW)

(21) Appl. No.: 19/024,638

(22) Filed: Jan. 16, 2025

(51) Int. Cl. H01C 7/02; C08F 14/22; C08F 210/02; C08F 214/26; C08K 3/04; C08K 3/26

(52) U.S. Cl. CPC H01C 7/027; C08F 14/22; C08F 210/02; C08F 214/26; C08K 3/04; C08K 3/26; C08K 2003/265; C08K 2201/001

(57) ABSTRACT

A positive temperature coefficient polymer composition includes a first polymer having a melting point ranging from 100° C. to 200° C., a second polymer having a melting point above 200° C., and a conductive filler. A weight ratio of the first polymer to the second polymer ranges from 1:5 to 5:1. A circuit protection device includes a polymeric positive temperature coefficient (PPTC) component and two electrodes respectively disposed on two opposite sides of the PPTC component. The PPTC component includes a polymer matrix and a conductive filler dispersed in the polymer matrix. The polymer matrix includes a first polymer that has a melting point ranging from 100° C. to 200° C., and a second polymer that has a melting point above 200° C. A weight ratio of the first polymer to the second polymer ranges from 1:5 to 5:1.

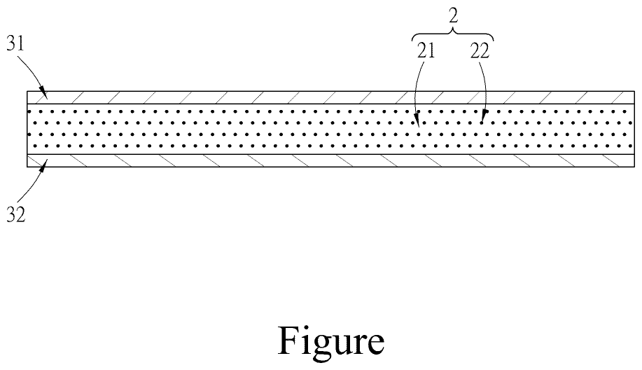

### FIELD

The disclosure relates to a positive temperature coefficient polymer composition and a circuit protection device containing the same.

### BACKGROUND

A positive temperature coefficient (PTC) component exhibits a PTC effect and could be used in a circuit protection device such as a resettable fuse. Such a PTC component may include a PTC polymeric unit, and first and second electrodes on two opposite surfaces of the PTC polymeric unit. The PTC polymeric unit includes a polymer matrix that contains a crystalline region and a non-crystalline region, and a particulate conductive filler that is dispersed in the non-crystalline region of the polymer matrix and that is formed into conductive pathways for electrical conduction between the first and second electrodes. The PTC effect is a phenomenon that occurs when the temperature of the polymer matrix is raised to its melting point, at which crystals in the crystalline region start to melt. This will result in the generation of a new non-crystalline region. As the new non-crystalline region expands to merge with the original non-crystalline region, the conductive pathways of the particulate conductive filler will gradually be cut off, and the resistance of the PTC polymer material will sharply increase. This will eventually result in the first and second electrodes becoming electrically disconnected from each other.

The circuit protection device may be used as a protection device in an electric apparatus. A material of the circuit protection device is designed according to a working temperature thereof. For example, polyolefin may generally be used for the polymer matrix if the working temperature is in a range from −40° C. to 85° C. In addition, polyvinylidene fluoride (PVDF) may be used for the polymer matrix if the working temperature is in a range from −40° C. to 125° C.

In application for overcurrent protection, circuit protection devices with relatively high working temperatures may be used at a high rated voltage, and are desired by the industry.

### SUMMARY

Therefore, an object of the disclosure is to provide a positive temperature coefficient polymer composition and a circuit protection device that can alleviate at least one of the drawbacks of the prior art.

According to a first aspect of the disclosure, a positive temperature coefficient polymer composition includes a first polymer, a second polymer and a conductive filler. The first polymer has a melting point ranging from 100° C. to 200° C., the second polymer has a melting point above 200° C. A weight ratio of the first polymer to the second polymer ranges from 1:5 to 5:1.

According to a second aspect of the disclosure, a circuit protection device includes a polymeric positive temperature coefficient (PPTC) component and two electrodes respectively disposed on two opposite sides of the PPTC component. The PPTC component includes a polymer matrix and a conductive filler dispersed in the polymer matrix. The polymer matrix includes a first polymer that has the melting point ranging from 100° C. to 200° C., and a second polymer that has the melting point above 200° C. A weight ratio of the first polymer to the second polymer ranges from 1:5 to 5:1.

### BRIEF DESCRIPTION OF THE DRAWING

Other features and advantages of the disclosure will become apparent in the following detailed description of the embodiment(s) with reference to the accompanying drawing. It is noted that various features may not be drawn to scale.

The sole figure is a schematic view illustrating a structure of a circuit protection device of an embodiment according to the present disclosure.

### DETAILED DESCRIPTION

Before the disclosure is described in greater detail, it should be noted that where considered appropriate, reference numerals or terminal portions of reference numerals have been repeated among the figure to indicate corresponding or analogous elements, which may optionally have similar characteristics.

Referring to the figure, an embodiment of a circuit protection device according to the present disclosure includes a polymeric positive temperature coefficient (PPTC) component 2, and two electrodes (31, 32) that are respectively disposed on two opposite sides of the PPTC component 2. The PPTC component 2 includes a polymer matrix 21 and a conductive filler 22 dispersed in the polymer matrix 21. The polymer matrix includes a first polymer that has a melting point ranging from 100° C. to 200° C. and a second polymer that has a melting point above 200° C. A weight ratio of the first polymer to the second polymer ranges from 1:5 to 5:1.

In some embodiments, the melting point of the second polymer is at least 50° C. higher than the melting point of the first polymer. In some embodiments, the first polymer has the melting point that ranges from 140° C. to 180° C., and the second polymer has the melting point that ranges from 200° C. to 280° C. In certain embodiments, the melting point of the first polymer is 170° C., and the melting point of the second polymer ranges from 220° C. to 223° C.

In some embodiments, the weight ratio of the first polymer to the second polymer ranges from 1:4 to 4:1. In some embodiments, the weight ratio of the first polymer to the second polymer ranges from 1:3 to 3:1. In some embodiments, the weight ratio of the first polymer to the second polymer ranges from 1:2 to 2:1. In certain embodiments, the weight ratio of the first polymer to the second polymer is 1:1.

In some embodiments, based on a total weight of the positive temperature coefficient polymer composition, each of the first polymer and the second polymer is in an amount ranging from 11 wt % to 46 wt %. In certain embodiments, each of the first polymer and the second polymer is in the amount ranging from 19 wt % to 38 wt %. In certain embodiments, the first polymer and the second polymer are in the amount of 28.8 wt %.

In some embodiments, the first polymer has a melt flow index (MFI) that ranges from 0.5 to 30 g/10 min at 230° C., and the second polymer has an MFI that ranges from 3 to 40 g/10 min at 297° C.

In some embodiments, the second polymer has a glass transition temperature (T_{g}) that is higher than a T_{g} of the first polymer. In certain embodiments, the first polymer has the T_{g} that is higher than −40° C., and the second polymer has the T_{g} that is higher than 50° C.

In some embodiments, the first polymer is selected from the group consisting of polypropylene (PP) and polyvinylidene fluoride (PVDF). In certain embodiments, the first polymer is PVDF. In some embodiments, the second polymer is selected from the group consisting of polyethylene terephthalate (PET), polyester, perfluoroalkoxy alkane (PFA), plyamide, polyacrylonitrile, polystyrene and ethylene tetrafluoroethylene (ETFE). In certain embodiments, the second polymer is ETFE.

In some embodiments, based on the total weight of the positive temperature coefficient polymer composition, the conductive filler is in an amount ranging from 30 wt % to 55 wt %. The conductive filler may be carbon black powder, carbon nanotube, graphene, metal powder, or conductive ceramic powder. In certain embodiments, the conductive filler is carbon black powder.

In some embodiments, the positive temperature coefficient polymer composition further includes a non-conductive filler. In some embodiments, based on the total weight of the positive temperature coefficient polymer composition, the non-conductive filler is in an amount ranging from 1 wt % to 5 wt %, e.g., 3 wt %. In certain embodiments, the non-conductive filler includes calcium carbonate.

The embodiment of the circuit protection device according to the present disclosure may have a working temperature ranging from −40° C. to 125° C., and may sustain a rated voltage that is higher than 16 Vdc.

The disclosure also provides a positive temperature coefficient polymer composition that is used to form the PPTC component 2 and that includes the first polymer, the second polymer and the conductive filler. The weight ratio of the first polymer to the second polymer ranges from 1:5 to 5:1. The positive temperature coefficient polymer composition may further include the non-conductive filler.

The present disclosure will be further described with reference to the following examples. However, it should be understood that the following examples are merely for illustration purposes and should not be considered as limitations to the implementation of the present disclosure.

### Example 1 (E1)

22.8 g of PVDF (commercially available from Arkema™ Inc., product name: Kynar® 761, melting point: 170° C., T_{g}:−35° C., MFI: 0.5 g/10 min at 230° C.), 5.7 g of ETFE (commercially available from Daikin Industries™, Ltd., product name: Neoflon® EP-610, melting point: 223° C., T_{g}: 80° C., MFI: 30 g/10 min at 297° C.), 20 g of carbon black powder (commercially available from Birla Carbon™ Inc., product name: Raven® 430 Ultra, DBP/D=0.95, and bulk density: 0.53 g/cm³), and 1.5 g of calcium carbonate (commercially available from Mei Lin White-Stone Chemicals™ Co., Ltd.) were compounded in a Brabender® mixer at 250° C. under 30 rpm for 10 minutes so as to obtain a compounded mixture. Then, the compounded mixture was hot pressed in a mold under 200° C. and 80 kg/cm² for 4 minutes to obtain a positive temperature coefficient (PTC) layer with a thickness of 0.35 mm. Two nickel-plated copper sheets were respectively attached to two opposite surfaces of the PTC layer, followed by hot pressing under 200° C. and 80 kg/cm² for 4 minutes to form a PTC laminate with a thickness of 0.42 mm. The PTC laminate was cut into chips, each of which has a size of 8 mm×8 mm. Then, each of the chips was irradiated with a cobalt-60 gamma ray for a total irradiation dose of 50 kGy to obtain a test sample having a structure as shown in the figure.

### Example 2 to Example 7 (E2 to E7)

The procedures and conditions in preparing the PTC devices of E2 to E7 were similar to those of E1, except for the amounts of PVDF and ETFE. The details are shown in Table 1.

### Example 8 to Example 12 (E8 to E12)

The procedures and conditions in preparing the PTC devices of E8 to E12 were similar to those of E1, except that the ETFE used in E8 to E12 was Neoflon® EP-620AS (commercially available from Daikin Industries™, Ltd., melting point: 220° C., T_{g}: 80° C., and MFI: 3 g/10 min at 297° C.). The details are shown in Table 1.

### Comparative Example 1 to Comparative Example 7 (CE1 to CE7)

The procedures and conditions in preparing the PTC devices of CE1 to CE7 were similar to those of E1, except for the amounts of PVDF and ETFE and the brand of ETFE. The details are shown in Table 1.

TABLE 1

| | First Polymer | Second Polymer | | |
|---|---|---|---|---|
| | Kyna^{r} ® | Neoflon ® | Neoflon ® | Weight Ratio of |
| | 761 | EP-610 | EP-620AS | First Polymer to |
| | (g) | (g) | (g) | Second Polymer |
| E1 | 22.80 | 5.70 | 0 | 4:1 |
| E2 | 21.38 | 7.13 | 0 | 3:1 |
| E3 | 19.00 | 9.50 | 0 | 2:1 |
| E4 | 14.25 | 14.25 | 0 | 1:1 |
| E5 | 9.50 | 19.00 | 0 | 1:2 |
| E6 | 7.13 | 21.38 | 0 | 1:3 |
| E7 | 5.70 | 22.80 | 0 | 1:4 |
| E8 | 22.80 | 0 | 5.70 | 4:1 |
| E9 | 19.00 | 0 | 9.50 | 2:1 |
| E10 | 14.25 | 0 | 14.25 | 1:1 |
| E11 | 9.50 | 0 | 19.00 | 1:2 |
| E12 | 5.70 | 0 | 22.80 | 1:4 |
| CE1 | 28.50 | 0 | 0 | 1:0 |
| CE2 | 25.65 | 2.85 | 0 | 9:1 |
| CE3 | 2.85 | 25.65 | 0 | 1:9 |
| CE4 | 0.00 | 28.50 | 0 | 0:1 |
| CE5 | 25.65 | 0 | 2.85 | 9:1 |
| CE6 | 2.85 | 0 | 25.65 | 1:9 |
| CE7 | 0.00 | 0 | 28.50 | 0:1 |

### Performance Tests

Resistance vs. Temperature Characteristic Evaluation

Ten test samples from each of E1 to E12 and CE1 to CE7 were subjected to resistance vs. temperature characteristic evaluation. The test samples were heated in an oven with a heating rate of 2° C./min from 25° C. to 250° C. The resistances (R₂₅, R₁₈₀, R₂₄₀) of each of the test samples at 25° C., 180° C. and 240° C. were measured. The results are presented in Table 2.

TABLE 2

| | RT Curve Test | | | Electric Performance | | | | |
|---|---|---|---|---|---|---|---|---|
| | R₂₅ | | | Breakdown | Switching | | | |
| | (Rᵢ) | R₁₈₀ | R₂₄₀ | Voltage | Cycles Test | | Aging Test | |
| | (ohm) | (ohm) | (ohm) | (V) | R_{f} | R_{f}/Rᵢ | R_{f} | R_{f}/Rᵢ |
| E1 | 0.0203 | 201.6 | 342.9 | 20 | 0.065 | 322% | 0.211 | 1039% |
| E2 | 0.0202 | 221.3 | 387.5 | 22 | 0.055 | 272% | 0.181 | 896% |
| E3 | 0.0198 | 243.7 | 567.8 | 24 | 0.048 | 242% | 0.140 | 707% |
| E4 | 0.0192 | 276.5 | 622.4 | 26 | 0.037 | 193% | 0.094 | 490% |
| E5 | 0.0195 | 244.7 | 577.1 | 24 | 0.044 | 226% | 0.133 | 682% |
| E6 | 0.0195 | 198.6 | 421.3 | 22 | 0.051 | 262% | 0.170 | 872% |
| E7 | 0.0205 | 100.5 | 359.7 | 20 | 0.059 | 288% | 0.198 | 966% |
| E8 | 0.0195 | 211.6 | 354.9 | 20 | 0.059 | 303% | 0.192 | 985% |
| ES | 0.0190 | 254.5 | 585.8 | 24 | 0.043 | 228% | 0.121 | 637% |
| E10 | 0.0183 | 301.4 | 657.7 | 26 | 0.031 | 167% | 0.072 | 393% |
| E11 | 0.0189 | 264.9 | 590.8 | 24 | 0.040 | 209% | 0.117 | 619% |
| E12 | 0.0194 | 118.3 | 365.8 | 20 | 0.051 | 264% | 0.169 | 871% |
| CE1 | 0.0221 | 256.3 | 274.2 | 16 | 0.158 | 715% | 0.865 | 3914% |
| CE2 | 0.0218 | 173.9 | 287.5 | 16 | 0.154 | 706% | 0.821 | 3766% |
| CE3 | 0.0213 | 18.60 | 298.5 | 16 | 0.128 | 601% | 0.801 | 3761% |
| CE4 | 0.0207 | 0.895 | 278.5 | 16 | 0.126 | 609% | 0.816 | 3942% |
| CE5 | 0.0204 | 185.5 | 296.2 | 16 | 0.140 | 686% | 0.801 | 3926% |
| CE6 | 0.0202 | 20.20 | 297.6 | 16 | 0.119 | 589% | 0.800 | 3960% |
| CE7 | 0.0201 | 0.956 | 298.5 | 16 | 0.123 | 612% | 0.805 | 4005% |

Table 2 shows that the resistances (R₂₄₀) of the PTC devices of E1 to E12 are in a range from 342.9 ohm to 622.4 ohm. However, the resistances (R₂₄₀) of the PTC devices of CE1 to CE7 are in a range from 274.2 ohm to 298.5 ohm, which are much smaller than the resistances (R₂₄₀) of the PTC devices of E1 to E12. The larger the resistance of the PTC device, the higher the rated voltage it may sustain. Thus, it is clear that, compared to CE1 to CE7, the PTC devices in E1 to E12 may withstand a higher rated voltage without damage.

### Breakdown Voltage Test

A breakdown voltage test on ten test samples of each of E1 to E12 and CE1 to CE7 was conducted by increasing in a stepwise manner a voltage applied to each of the test samples from an initial voltage of 10 Vdc to a breakdown voltage under a current of 100 A. The applied voltage was increased at an increment of 2 Vdc per step, and the duration time for each step was 2 minutes (i.e., each newly applied voltage lasted for two minutes). An average breakdown voltage of the test samples in each of the examples and comparative examples are presented in Table 2. It reveals in Table 2 that the breakdown voltages of the test samples in E1 to E12 (ranging from 20 V to 26 V) are significantly higher than the breakdown voltages of the test samples in CE1 to CE7 (16 V). This may be attributed to the high resistances of the test samples in E1 to E12 at 240° C.

### Switching Cycle Test

The test samples of E1 to E12 and CE1 to CE7 were subjected to a switching cycle test under a voltage of 16 Vdc and a current of 10 A by switching each test sample on for 60 seconds and then off for 60 seconds per cycle for 6000 cycles. The resistances of each of the test samples before (Rᵢ) and after (R_{f}) the 6000 cycles were measured, in which Rᵢ equaled to R₂₅. A percentage of average resistance variation (R_{f}/Rᵢ×100%) of each of the test samples was calculated and is presented in Table 2.

From Table 2, it is apparent that the percentages of average resistance variations of test samples of E1 to E12 (ranging from 167% to 322%) are much lower than those in CE1 to CE7 (ranging from 589% to 715%), and the test samples of E4 and E10 have the lowest percentage of average resistance variations. The results show that, compared to the test samples of CE1 to CE7, the test samples of E1 to E12 exhibit superior stability and durability.

### Aging Test

An aging test was conducted on test samples of E1 to E12 and CE1 to CE7, where each of the test samples of E1 to E12 and CE1 to CE7 was applied with a current of 10 A and a voltage of 16 Vdc for 1000 hours. For each of the test samples, an initial resistance (Rᵢ) was taken before the current and voltage were applied, and a final resistance (R_{f}) was taken after 1000 hours of applying the current and voltage. A percentage of average resistance variations (R_{f}/Rᵢ×100%) in each of the test samples of E1 to E12 and CE1 to CE7 was calculated and is presented in Table 2.

It is shown in Table 2 that percentages of the average resistance variations of the test samples of E1 to E12 (ranging from 393% to 1039%) are much lower than those in CE1 to CE7 (ranging from 3761% to 4005%), and the test samples of E4 and E10 have the lowest percentages of the average resistance variations. The results show that, compared to the test samples of CE1 to CE7, the test samples of E1 to E12 exhibit superior stability and durability.

In summary, with the combination of the first polymer and the second polymer each having particular ranges of melting point, and the specific weight ratio of the first polymer to the second polymer, the breakdown voltage and reliability of the circuit protection device may be significantly improved. The circuit protection device of the present disclosure may have a working temperature ranging from −40° C. to 125° C. and may sustain a rated voltage higher than 16 V.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A positive temperature coefficient polymer composition, comprising:
a first polymer having a melting point ranging from 100° C. to 200° C.;
a second polymer having a melting point above 200° C., a weight ratio of said first polymer to said second polymer ranging from 1:5 to 5:1; and
a conductive filler.

2. The positive temperature coefficient polymer composition as claimed in claim 1, wherein the melting point of said second polymer is at least 50° C. higher than the melting point of said first polymer.

3. The positive temperature coefficient polymer composition as claimed in claim 1, wherein the weight ratio of said first polymer to said second polymer ranges from 1:4 to 4:1.

4. The positive temperature coefficient polymer composition as claimed in claim 1, wherein the weight ratio of said first polymer to said second polymer ranges from 1:3 to 3:1.

5. The positive temperature coefficient polymer composition as claimed in claim 1, wherein the weight ratio of said first polymer to said second polymer ranges from 1:2 to 2:1.

6. The positive temperature coefficient polymer composition as claimed in claim 1, wherein the weight ratio of said first polymer to said second polymer is 1:1.

7. The positive temperature coefficient polymer composition as claimed in claim 1, wherein based on a total weight of said positive temperature coefficient polymer composition, at least one of said first polymer and said second polymer is in an amount ranging from 11 wt % to 46 wt %.

8. The positive temperature coefficient polymer composition as claimed in claim 1, wherein said first polymer has a melting point that ranges from 140° C. to 180° C., and said second polymer has a melting point that ranges from 200° C. to 280° C.

9. The positive temperature coefficient polymer composition as claimed in claim 1, wherein said first polymer has a melt flow index that ranges from 0.5 to 30 g/10 min at 230° C., and said second polymer has a melt flow index that ranges from 3 to 40 g/10 min at 297° C.

10. The positive temperature coefficient polymer composition as claimed in claim 1, wherein said first polymer is selected from the group consisting of polypropylene (PP) and polyvinylidene fluoride (PVDF).

11. The positive temperature coefficient polymer composition as claimed in claim 1, wherein said second polymer is selected from the group consisting of polyethylene terephthalate (PET), polyester, perfluoroalkoxy alkane (PFA), plyamide, polyacrylonitrile, polystyrene and ethylene tetrafluoroethylene (ETFE).

12. A circuit protection device, comprising:
a polymeric positive temperature coefficient (PPTC) component including a polymer matrix and a conductive filler dispersed in said polymer matrix, said polymer matrix including a first polymer that has a melting point ranging from 100° C. to 200° C., and a second polymer that has a melting point above 200° C.; and
two electrodes respectively disposed on two opposite sides of said PPTC component,
wherein a weight ratio of said first polymer to said second polymer ranges from 1:5 to 5:1.

13. The circuit protection device as claimed in claim 12, wherein the melting point of said second polymer is at least 50° C. higher than the melting point of said first polymer.

14. The circuit protection device as claimed in claim 12, wherein the weight ratio of said first polymer to said second polymer ranges from 1:4 to 4:1.

15. The circuit protection device as claimed in claim 12, wherein the weight ratio of said first polymer to said second polymer ranges from 1:3 to 3:1.

16. The circuit protection device as claimed in claim 12, wherein the weight ratio of said first polymer to said second polymer ranges from 1:2 to 2:1.

17. The circuit protection device as claimed in claim 12, wherein based on a total weight of said positive temperature coefficient polymer composition, at least one of said first polymer and said second polymer is in an amount ranging from 11 wt % to 46 wt %.

18. The circuit protection device as claimed in claim 12, wherein said first polymer has a melting point that ranges from 140° C. to 180° C., and said second polymer has a melting point that ranges from 200° C. to 280° C.

19. The circuit protection device as claimed in claim 12, wherein said first polymer is selected from the group consisting of polypropylene (PP) and polyvinylidene fluoride (PVDF).

20. The circuit protection device as claimed in claim 12, wherein said second polymer is selected from the group consisting of polyethylene terephthalate (PET), polyester, perfluoroalkoxy alkane (PFA), plyamide, polyacrylonitrile, polystyrene and ethylene tetrafluoroethylene (ETFE).
